(19) United States
(12) Patent Application Publication
(10) Pub. No.: US 2014/0156315 A1
(43) Pub. Date: Jun. 5, 2014

(54) Settlement Evaluation Tool for Subrogation Recovery Enhancement

(71) Applicant: ExlService Holdings, Inc., New York, NY (US)

(72) Inventors: Adolfo E. Canovi, Bloomfield, CT (US); Lauren K. Bush, West Haven, CT (US); Donald R. Pierce, Jr., Enfield, CT (US); Zachary Russell Hodges, Columbia, SC (US); Michael Joseph Paolino, Jr., Columbia, SC (US); R. Bradley Burdick, West Hartford, CT (US)

(73) Assignee: ExlService Holdings, Inc., New York, NY (US)

(21) Appl. No.: 14/098,300

(22) Filed: Dec. 5, 2013

Related U.S. Application Data
(60) Provisional application No. 61/797,348, filed on Dec. 5, 2012.

(51) Int. Cl. G06Q 40/08

(52) U.S. Cl. CPC G06Q 40/08
USPC 705/4

(57) ABSTRACT

A settlement evaluation tool includes a settlement evaluation module having a statistical model, and an inquiry portal module. The inquiry portal module is configured to perform operations that include electronically receiving data related to an insurance liability dispute between a first insurance carrier and a second insurance carrier, and transferring the data to the settlement evaluation module. The settlement evaluation module is configured to perform operations that include applying the statistical model to the data to obtain an outcome probability associated with a strategy for resolving the dispute, and outputting the outcome probability.

### CROSS-REFERENCE TO RELATED APPLICATION

This application claims the benefit of priority to U.S. Provisional Patent Application No. 61/797,348, filed Dec. 5, 2012, the entire contents of which are incorporated herein by reference.

### TECHNICAL FIELD

The present disclosure relates to settlement evaluation tools for subrogation recovery and enhancement.

### BACKGROUND

In scenarios involving the damage and/or loss of property incurred by a first party as a result of the actions of a second adverse party (a “loss event”), where both parties are insured, the insurer of the first party may subrogate the first party's claims against the insurer of the adverse party. Subrogation refers generally to circumstances in which a first insurance carrier or other entity (a “Demanding Carrier”) tries to recoup expenses from a second insurance carrier (a “Responding Carrier”) for an insurance claim the Demanding Carrier paid out when another party should have been responsible for paying at least a portion of the claim. More generally, the Demanding Carrier takes over the rights of the first party to assert a claim for recovery against the second party. In subrogation, there are various stages in the recovery process where an insurance adjustor can have a positive impact on the recovery outcome. An adjustor generally relies only on his experience and expertise when participating in the recovery process, e.g., at the stage of initial contact with the adverse party, during negotiation of a demand to recover costs for a claim, and prior to escalation to a more costly phase of the recovery cycle. This often may result in less than optimal outcomes, including more costly recovery costs and elongated recovery timelines.

### SUMMARY

The present disclosure relates to techniques and tools for aiding the recovery process during subrogation for either a Demanding Carrier or Responding Carrier, in which such techniques and tools rely on the use of predictive analytics to minimize costs and enhance the efficiency of the recovery effort. In particular, the settlement evaluation techniques and tools described herein provide an adjustor (from a Demanding Carrier or a Responding Carrier) with real-time decision support that enables the adjustor to improve the outcome for each insurance claim handled. The process may include applying one or more of a first set of statistical models to information relating to a particular loss event to obtain a predictive output that includes a probability distribution for different recovery outcomes. The process also may entail applying one or more of a second set of statistical models to determine an accuracy of the predictive output. The tools described herein can be incorporated, for example, as part of an intelligent electronic subrogation network that automates intra-organization workflow, inter-organization workflow and collaboration for insurance subrogation.

In general, in a first aspect, the subject matter of the present disclosure can be embodied in systems that include a settlement evaluation module including a statistical model, and an inquiry portal module. The inquiry portal module is configured to perform operations including providing an interactive user interface for display on a display device, electronically receiving, from the interactive user interface, data related to a subrogation demand from a first insurance carrier against a second insurance carrier for an insurance claim covering a loss event, transferring the data to the settlement evaluation module. The settlement evaluation module is configured to perform operations including applying the statistical model to the data to obtain an outcome probability associated with a strategy for resolving the subrogation demand, and outputting the outcome probability to the inquiry portal module for display within the interactive user interface, in which the interactive user interface includes the outcome probability associated with the strategy, an historical overview of events related to the subrogation demand, information about the loss event, a status of the subrogation demand, or combinations thereof.

The systems may include one or more of the following features. For example, in some implementations, the user-interactive interface is configured to include an interactive tool that allows a user to obtain a revised outcome probability based on a modification of the data.

In some implementations, the strategy for resolving the subrogation demand includes seeking settlement of the dispute, seeking arbitration of the dispute, litigating the dispute, or combinations thereof, and the outcome probability includes a probability that the second insurance carrier submits a payment to the first insurance carrier, a projected payment amount to the first insurance carrier from the second insurance carrier upon resolution of the dispute, a projected time until the first insurance carrier will recover a payment from the second insurance carrier, or combinations thereof.

In another aspect, the subject matter of the present disclosure may be embodied in computer-implemented methods that include electronically providing, from a first data processing apparatus to a second data processing apparatus, data related to a subrogation demand from a first insurance carrier against a second insurance carrier for an insurance claim covering a loss event, electronically receiving from the second data processing apparatus an outcome probability associated with a strategy for resolving the subrogation demand, in which the outcome probability is obtained by applying a statistical model to the data related to the subrogation demand, and presenting the outcome probability within an interactive user interface on a display device.

The computer-implemented methods may include one or more of the following features. For example, in some implementations, the interactive user interface includes information comprising an historical overview of events related to the subrogation demand, information about the loss event, a status of the subrogation demand, or combinations thereof.

In some implementations, the strategy for resolving the subrogation demand includes seeking settlement of the dispute, seeking arbitration of the dispute, litigating the dispute, or combinations thereof, and the outcome probability includes a probability that the second insurance carrier submits a payment to the first insurance carrier, a projected payment amount to the first insurance carrier from the second insurance carrier upon resolution of the dispute, a projected time until the first insurance carrier will recover a payment from the second insurance carrier, or combinations thereof.

In another aspect, the subject matter of the disclosure can be embodied in systems that include a settlement evaluation module having a statistical model, and an inquiry portal module. The inquiry portal module is configured to perform operations that include electronically receiving data related to an insurance liability dispute between a first insurance carrier and a second insurance carrier, and transferring the data to the settlement evaluation module. The settlement evaluation module is configured to perform operations that include applying the statistical model to the data to obtain an outcome probability associated with a strategy for resolving the dispute, and outputting the outcome probability.

The aspect may include one or more of the following features. For example, in some implementations, the settlement evaluation module includes a database configured to store actual outcomes of prior disputes between insurance carriers, outcome probabilities associated with prior disputes between insurance carriers, or combinations thereof.

In some implementations, the statistical model is constructed based on the actual outcomes of the prior disputes, the outcome probabilities associated with the prior disputes, or the combinations thereof.

In some implementations, the dispute may include a demand from the first insurance carrier for payment from the second insurance carrier for an insurance claim submitted by a party insured by the first insurance carrier. The insurance claim may cover a loss event. The data related to the dispute may include information about a type of loss that occurred in the loss event, a description of the loss event, a location where the loss event occurred, environmental conditions associated with the loss event, information about the second insurance carrier, information about costs associated with the loss event, or combinations thereof.

In some implementations, the settlement evaluation module is configured to perform operations further including applying multiple statistical models to the data to obtain multiple outcome probabilities, in which each outcome probability is associated with a different strategy for resolving the dispute. The plurality of outcome probabilities comprise a probability that a resolution to the dispute includes payment from the second insurance carrier to the first insurance carrier, a projected payment amount to the first insurance carrier from the second insurance carrier upon resolution of the dispute, a projected time until the first insurance carrier will recover a payment from the second insurance carrier, or combinations thereof. The different strategies for resolving the dispute may include seeking settlement of the dispute, seeking arbitration of the dispute, litigating the dispute, or combinations thereof.

In some implementations, the settlement evaluation module is configured to perform operations that further include applying an additional statistical model to the outcome probability to obtain a confidence estimate in the outcome probability, and outputting the confidence estimate to the inquiry portal module. The inquiry portal module may be configured to perform operations further that further include displaying a visual indicator to indicate the confidence estimate, in which the visual indicator includes a color-coded indicator of the confidence estimate.

In some implementations, the settlement evaluation module is configured to perform operations that further include identifying a probability that the strategy for resolving the dispute will be used.

In another aspect, the subject matter of the present disclosure may be embodied in a computer-implemented method that includes electronically receiving, at one or more data processing apparatuses, data related to an insurance liability dispute between a first insurance carrier and a second insurance carrier, using the one or more data processing apparatuses to apply a statistical model to the data to obtain an outcome probability associated with a strategy for resolving the dispute, and outputting the outcome probability.

The computer-implemented methods may include one or more of the following features. For example, in some implementations, the statistical model is constructed based on the actual outcomes of the prior disputes, the outcome probabilities associated with the prior disputes, or the combinations thereof.

In some implementations, the dispute includes a demand from the first insurance carrier for payment from the second insurance carrier for an insurance claim submitted by a party insured by the first insurance carrier. The insurance claim may cover a loss event in which the data related to the dispute includes information about a type of loss that occurred in the loss event, a description of the loss event, a location where the loss event occurred, environmental conditions associated with the loss event, information about the second insurance carrier, information about costs associated with the loss event, or combinations thereof.

In some implementations, the computer-implemented methods further include using the one or more data processing apparatuses to apply a plurality of statistical models to the data to obtain multiple outcome probabilities, each outcome probability being associated with a different strategy for resolving the dispute. The multiple outcome probabilities may include a probability that a resolution to the dispute includes payment from the second insurance carrier to the first insurance carrier, a projected payment amount to the first insurance carrier from the second insurance carrier upon resolution of the dispute, a projected time until the first insurance carrier will recover a payment from the second insurance carrier, or combinations thereof. The different strategies for resolving the dispute may include seeking settlement of the dispute, seeking arbitration of the dispute, litigating the dispute, or combinations thereof.

In some implementations, the computer-implemented methods further include using the one or more data processing apparatuses to apply an additional statistical model to the outcome probability to obtain a confidence estimate in the outcome probability, and outputting the confidence estimate to the inquiry portal module. The inquiry portal module may be configured to perform operations further including displaying a visual indicator to indicate the confidence estimate, in which the visual indicator includes a color-coded indicator of the confidence estimate.

In some implementations, the computer-implemented methods further include identifying a probability that the strategy for resolving the dispute will be used.

The foregoing aspects may include one or more of the following advantages. For example, in some implementations, the presently described tools and techniques may help an insurance carrier obtain consistently optimal outcomes, which may not be achievable by individual adjustors handling claims on their own. Such optimal results include, for example, reduced costs due to increased efficiency in the recovery process and less time managing and overviewing claims. Increased savings may be achieved from more consistently maximizing recovered costs on the Demanding Carrier side or minimizing payments from the Responding Carrier side. In some implementations, the tools and techniques may be useful to help accelerate the training of entry level staff that do not have extensive business knowledge derived from many years of practicing in the insurance industry, thus enhancing productivity. In some implementations, the techniques and tools may improve the cash flow for an insurance carrier by reducing the number of times a claim is handled (e.g., back and forth exchanging of information between carriers) with ineffective action in the recovery process. Other advantages include, for example, enabling adjustors to make rapid, accurate and more confident decisions; helping reduce adjustor errors, aiding in the reduction of costly reviews, enabling prioritization of claims with high recovery likelihood and quick settlement times. In addition, the techniques and tools are not limited to subrogation, but may be used in any applicable claim negotiation process.

For the purposes of this disclosure, “automatically” is understood to mean without human intervention.

The details of one or more embodiments are set forth in the accompanying drawings and the description below. Other features and advantages will be apparent from the description, the drawings and from the claims.

### BRIEF DESCRIPTION OF THE DRAWINGS

FIG. 1 is a schematic that illustrates an example settlement evaluation system.

FIG. 2 is a flow chart that illustrates an example of a process by which the subrogation of an insurance claim may be evaluated.

FIGS. 3-6 are screenshots of example settlement evaluation web pages.

FIG. 7 is a screenshot of an example settlement evaluation page that includes an interactive pop-up window.

FIG. 8 is a screenshot of an example settlement evaluation web page.

FIG. 9 is a screenshot of a section of a settlement evaluation web page that provides a user with information about a recovery analysis.

FIG. 10 is a schematic that illustrates an example of an application framework on which the configuration of a settlement evaluation system may be based.

### DETAILED DESCRIPTION

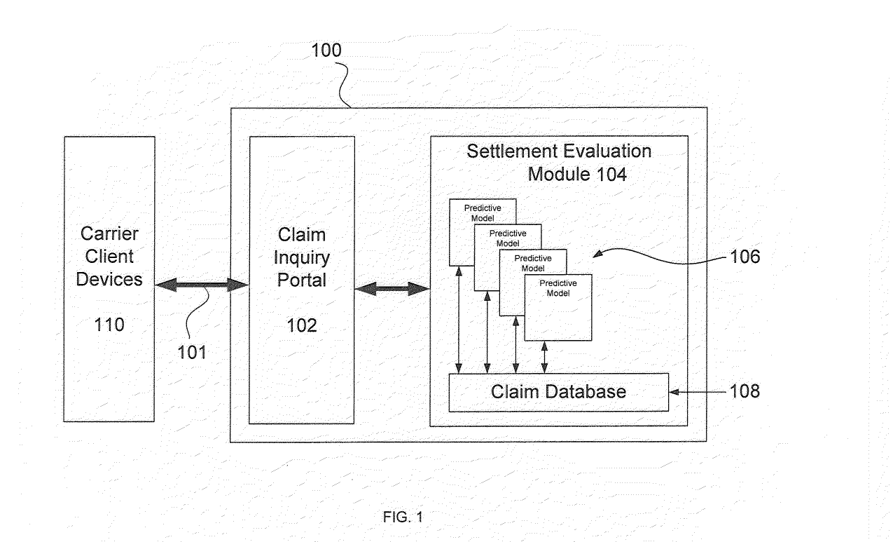

FIG. 1 is a schematic that illustrates an example interactive settlement evaluation system 100 configured to perform operations that include, among other things, receiving information regarding insurance claims subject to subrogation, evaluating the received information to obtain assessments of various different recovery approaches for the insurance claims, and providing details of the assessments as an output to a user. The system 100 also provides a data presentation format that allows a carrier to ascertain the current state of the insurance claim covering a particular loss event relative to other insurance claims covering loss events having similar characteristics. The data presentation format also provides the carrier with information as to the where in the recovery cycle the optimal recovery outcome is likely to be achieved.

Following an incident involving a loss (injury or property loss), an insurance carrier for the party incurring the loss (the Demanding Carrier) may use the system 100 to evaluate the insurer's options for recovering from an adverse carrier (the Responding Carrier) costs associated with compensating the injured party. The Demanding Carrier (e.g., an adjustor working for the Demanding Carrier) provides the system 100 with information related to the loss event, after which the system 100 applies one or more statistical models to the information to obtain a predictive output that includes a set of possible recovery outcomes/approaches. The predictive output also may include further details such as, but not limited to, the likelihood of success of each of the different recovery outcomes, the projected recovery amount associated with each different recovery outcome, and/or the anticipated time until recovery is obtained for each of the different recovery outcomes. With the foregoing information in hand, the Demanding Carrier may select a recovery strategy that will allow the Demanding Carrier to minimize costs associated with a particular claim.

The system 100 is not limited to use by Demanding Carriers seeking recovery of costs through subrogation, but may also be used by Responding Carriers seeking to minimize their liability and payments to a Demanding Carrier. For example, the system 100 may analyze information related to a loss event using one or more statistical models and provide a Responding Carrier with a predictive output that includes a set of possible settlement outcomes/approaches along with details as to the likelihood of success of the different settlement approaches, the projected recovery amount associated with each different settlement approach, and/or the anticipated time until the different settlement approaches will be completed.

As will be explained in detail further below, the system 100 can be implemented using one or more server devices (e.g., data processing apparatuses) that are connected to one or more computer networks 101 (e.g., the Internet, local area networks, wide area networks, system area networks, etc.). The system 100 uses the network(s) 101 to receive data from and transfer data to one or more client devices 110 operated by the carrier (e.g., the Demanding Carrier or Responding Carrier). In some implementations, the client devices 110 are coupled to the system 100 over a defined network of devices that belongs to the insurance carrier, such as a local area network, that can communicate with a larger network, such as the Internet. In other implementations, the system 100 is implemented on the client device itself instead of one or more servers. For the purposes of this disclosure, the Demanding Carrier or Responding Carrier's “use” of the system 100 or any portion of the system 100 is understood to include the use of the system 100 or any portion of the system 100 by an employee/contractor/laborer of the Demanding Carrier or of the Responding Carrier.

In addition, for the purposes of this disclosure, a client device 110 is an electronic device that is under control of a user, that has one or more data processing apparatuses, and that is capable of requesting, receiving and transmitting resources and/or information over the network 101. Examples of client devices include personal computers, mobile communication devices (e.g., smartphones or pad computing devices), and other devices that can send and receive data over the network 101. A client device 110 can include one or more user applications, such as a web browser, to facilitate the sending and receiving of data over the network 101. Similar to a client device, a given server device includes one or more electronic processors that are capable of requesting, receiving, and transmitting resources and/or data over the network 101, in which the server device is under the control of a user. The server devices can communicate with each other and with storage systems (e.g., databases such as carrier account databases for storing carrier information and web databases for storing resources associated with a website hosted by the server device) at various times using one or more computer networks and/or communication devices. For example, the server devices can communicate through shared memory, network communication, or other means of inter or intra-process communication. A storage system can include, for example, a database server on which data and other information is stored. The one or more server devices can communicate through the network 101 with one or more of the client devices 110.

In general, the system 100 can be configured, for example, to include a claim inquiry portal 102 and a settlement evaluation module 104. The claim inquiry portal 102 provides an access point for an insurance carrier (either a Demanding Carrier or Responding Carrier) to, among other things, submit information related to one or more insurance claims potentially subject to subrogation, view the status of one or more insurance claims, view recovery/settlement options for an insurance claim, view an historical overview of the settlement process with respect to an insurance claims, evaluate other similar insurance claims against which settlement options may be benchmarked, assess details related to a loss event underlying an insurance claim, and/or modify parameters of the insurance claim so as to evaluate recovery/settlement options under different scenarios. The inquiry portal 102 may include a web application that hosts a user interactive interface, such as a website with which the carrier can interact (e.g., supply and obtain information regarding claims). Alternatively, or in addition, the inquiry portal 102 may include system hardware running a software application that a carrier can remotely log into using a client computing device.

The settlement evaluation module 104 is coupled to the claim inquiry portal 102 such that the module 104 provides information to and receives information from the portal 102. The settlement evaluation module 104 includes one or more statistical models 106 and one or more claim databases 108. Using the information provided through the portal 102, from the databases 108 and/or from other sources, the settlement evaluation module 104 runs the one or more predictive and analytical statistical models to obtain a probability distribution for a set of possible recovery/settlement outcomes. A wide range of models can be used and the system 100 is not limited to any particular models. Model selection and fine tuning is based on multiple factors, including overall desired negotiation process and strategy, necessary model output to drive negotiating behavior by the Demanding Carrier, effective model output that allows to shortcut the negotiating process of Responding Carriers, desirability of self-adjusting models and balance of availability of historical data versus experienced staff processing and negotiating insights. The statistical models are constructed, in part, based on the information available from the database 108 such as the actual outcomes of the prior disputes, the outcome probabilities associated with the prior disputes, or combinations thereof. The settlement evaluation module 104 may be configured to use various different models including, but not limited to, predictive and Bayesian models. The output of the models may then be passed back to the inquiry portal 102 for viewing by the carrier, e.g., on the client device 110. The settlement module 104 may be implemented using a combination of system hardware and software that configures the hardware to perform the techniques described herein.

The information stored by the one or more claims databases 108 and used by the statistical models 106 includes, for example, information received from the inquiry portal 102 relating to a particular insurance claim, information output by the statistical models 106 subsequent to evaluating insurance claims, and historical information relating to prior insurance claims. For example, the databases 108 may be configured to store actual outcomes of prior disputes between insurance carriers, outcome probabilities associated with prior disputes between insurance carriers, or combinations thereof.

Information received and/or displayed by the inquiry portal 102 may include details regarding the loss event underlying the insurance claim such as, for example, the type of loss that occurred in the loss event (e.g., partial or total loss of property), a description of the loss event/the primary accident cause (e.g., as to automobiles: lane departure collision, collision at an intersection, collision with an off-road object, head-on, side or rear-end collision, or collision with a pedestrian), the location where the loss event occurred (e.g., city, state, highway, local road, bay, river, ocean, court jurisdiction, etc.), and/or the environmental conditions associated with the loss event (e.g., whether there was rain, fog, snow, ice, etc.). The information received through the inquiry portal 102 also may include details regarding the parties involved in the loss event such as, for example, the parties' names, addresses, age, or insurance policy number. The information received from the portal 102 also may include details regarding costs associated with the loss event such as, for example, costs associated with replacement of parts, salvage costs, costs for rentals, labor, towing, and deductibles paid by the insured party, among others. The costs may have been paid out by the insurance carrier or may include estimates. The information received from the portal 102 also may include electronic files, such as text documents, image documents, video documents, and/or audio documents relating to the loss event. For example, the electronic documents may include estimates, images of receipts, images/video of damage to property (e.g., images of damaged property procured by an insurance inspector), images/video of the location where the loss event occurred, and/or voice recordings. In some implementations, the electronic documents include pre-filled forms containing information pertaining to the loss event. Examples of such forms include loss report forms from third party vendors such as ISO, Inc.® and ACORD®. The forms may include standard electronic forms from which information is extracted by parsing the files for the desired fields.

Historical information may include details about previously closed insurance claims. For each previous claim, the information includes, for example, the name of the adverse insurance carrier, the type of loss that occurred in the loss event, a description of each loss event/the primary accident cause, the location where the loss event occurred, the damage that was incurred, the amount recovered by the Demanding Carrier or saved by the Responding Carrier at close of the claim, the phase of recovery reached or strategy employed (e.g., settlement, arbitration, or litigation) at closing of the claim, and/or the time needed to reach close of recovery. In addition, the historical information may include information about the laws of different jurisdictions in which loss events may occur. For example, different jurisdictions may have different laws pertaining to negligence and recovery for damages. For instance, jurisdictions may include caps on damages or may have different time periods in which litigation or arbitration must proceed. The statistical models may incorporate this jurisdictional information as an input factor in providing recovery assessments.

Information output by the statistical models 106 subsequent to evaluating insurance claims may include, for example, the percentage of insurance claims having a particular set of characteristics that have been settled, arbitrated, or litigated, the likelihood that a recovery will be obtained under each of the foregoing recovery stages, projected amounts of recovery under each of the foregoing recovery stages, the anticipated time until recovery under each of the foregoing recovery stages, and/or the accuracy of the predictions as to likelihood of recovery, projected recovery amount, and time estimates.

The settlement evaluation engine 104 may employ various different statistical models. For example, a first type of model is a recovery likelihood model. The recovery likelihood model generates a predicted likelihood that at least some of the costs expended for the claim will be recovered from an adverse carrier. The recovery likelihood models may utilize a logistics regression approach which results in a probability estimate of the likelihood that a recovery will be obtained. Different sub-types of recovery likelihood models may be used including, for example, settlement, arbitration and litigation recovery likelihood models. A settlement recovery likelihood model is a recovery likelihood model based on historical insurance claims that were closed using a settlement strategy. An arbitration recovery likelihood model is a recovery likelihood model based on historical claims that were closed using an arbitration strategy. A litigation recovery likelihood model is a recovery likelihood model based on historical claims that were closed using a litigation strategy.

A second type of model is a projected recovery amount model. Projected recovery amount models provide a predicted value (e.g., in dollar amount) that the Demanding Carrier is expected to recover. The projected recovery amount models may utilize a logistics regression approach that results in a probability estimate of the total amount of recovery to be obtained. When outputting the projected recovery values, the settlement evaluation tool 104 may adjust the values depending on the percentage liability that can be attributed to the Demanding Carrier and to the Responding Carrier. Such adjustments may ensure that the projected amount is proportional to the percentage liability attributed to the Responding Carrier. Different sub-types of projected recovery amount models may be used including, for example, settlement, arbitration and litigation projected recovery amount models. A projected settlement recovery amount model is a projected recovery model based on historical insurance claims that had closed with recoveries using a settlement strategy. A projected arbitration recovery amount model is a projected recovery amount model based on historical claims that were closed with recoveries using an arbitration strategy. A projected litigation recovery amount model is a projected recovery amount model based on historical claims that were closed with recoveries using a litigation strategy.

A third type of model is a time to recovery model. Time to recovery models provide an indication of the amount of time it may take to reach the close of recovery. The time to recovery models may utilize a logistics regression approach that results in a probability estimate of the time until the close of recovery. Different sub-types of time to recovery models may be used including, for example, settlement, arbitration and litigation time to recovery models. A projected settlement time to recovery model is a projected recovery model based on historical insurance claims that had closed with recoveries using a settlement strategy. A projected arbitration time to recovery model is a projected recovery amount model based on historical claims that were closed with recoveries using an arbitration strategy. A projected litigation time to recovery model is a projected recovery amount model based on historical claims that were closed with recoveries using a litigation strategy.

A fourth type of model is a phase (historical choice) model. The phase model provides a percentage of previously closed insurance claims matching specified characteristics that have been settled, arbitrated or litigated with an adverse carrier. A user may specify the characteristics (e.g., accident cause, adverse insurance carrier, percentage of Demanding Carrier or Responding Carrier liability, etc.) of an insurance claim to be evaluated using the inquiry portal 102. The settlement evaluation tool 104 then applies the phase model to the specified characteristics to obtain a distribution of the different types of recovery actions that historically have been pursued for that particular set of characteristics.

A fifth type of model is a confidence model. A confidence model provides confidence estimates as to the accuracy of the different model outputs based on a comparison of actual values with the predicted values and/or by analyzing the expected performance of multiple segments of the predictive model and their contribution to its output from a statistical error perspective. For example, a confidence estimate in the output of a recovery likelihood model may be obtained by comparing the actual likelihood of recovery with the predicted likelihood of recovery in each segment defined by a combination of inputs to the model (e.g., inputs such as Responding Carrier, state where loss event occurred, loss type, among others). The settlement evaluation tool 104 may use the confidence estimates to keep or discard the predicted outcomes of the models. For example, in some implementations, the settlement evaluation tool may discard projected likelihood of recovery values that are more than 3 standard deviations away from the actual likelihood of discovery values. In general, differences, e.g., of more than 3 standard deviations are not reliable enough to report.

In some implementations, the settlement evaluation module 104 identifies, based on historical information about insurance claims, specific expected negotiating behavior for each adverse carrier by state and/or accident cause. The expected negotiating behavior includes historical information about likelihood of recovery from each adverse carrier by state and/or accident cause, the value of recovery obtained from each adverse carrier by state and/or accident cause, and the time until recovery experienced with the adverse carrier by state and/or accident cause. Each adverse carrier then is ranked according to its expected negotiating behavior, and the ranking may be used as an input factor by the statistical models in determining the predicted outcome for the current claim. Preferably, in obtaining the expected negotiating behavior for each adverse carrier, the settlement evaluation module 104 relies on a minimum number of historical insurance claims to ensure a reliable estimate of the adverse carrier response. For example, the settlement evaluation module 104 may look to at least 10 or more historical insurance claims for a particular adverse carrier to determine the adverse carrier's expected negotiating behavior. Adverse carrier liability levels, the presence of salvage dollars, and interactions between factors may also be considered as inputs to the models. Since the foregoing factors are often determined late in the negotiating process, these factors can be useful to evaluate using the “what-if” tool of the system 100, described further below.

In some implementations, the expected negotiating behaviors of adverse carriers are similar across states or other categories. In such cases, the similar behaviors may be grouped together when used as input factors by the statistical models to reduce processing time and increase individual prediction accuracy. In addition, each grouping may contain specific coefficients and formulas that are applied to the inputs to achieve immediate calculation of the predictions, allowing an almost instantaneous calculation of the statistical model output.

In certain implementations, the statistical models enable insurance carriers to obtain in improvements in claim processing efficiency and a reduction in recovery costs. For example, if the output of the statistical models indicates that the likelihood of recovery for a particular claim is either very high (e.g., greater than 80% probability, greater than 85% probability, greater than 90% probability, or greater than 95% probability) or very low (e.g., less than 20% probability, less than 15% probability, less than 10% probability, or less than 5% probability), then a user (e.g., adjustor) processing the claim on behalf of the insurance carrier requires very little expertise on how to process the claim. Accordingly, such high certainty claims may be assigned to new user without requiring a substantial amount of time to train the new user in how to process the claim. By reducing the amount of time the user needs to invest in processing the claim, the turnover rate at which claims may be processed increases, improving customer satisfaction, improving loss ratio and expense ratios, and reducing overall cycle time. In another example, the models may be able to identify recovery approaches that are either likely to be successful or that maximize recovery more often than a user alone. As a result, the insurance carrier may experience a growth in revenue from a greater number of successful recoveries and from recoveries that are higher in value at the close of the recovery process. Additionally, the increases in speed at which claims are processed also may improve revenues by decreasing latencies in recovery.

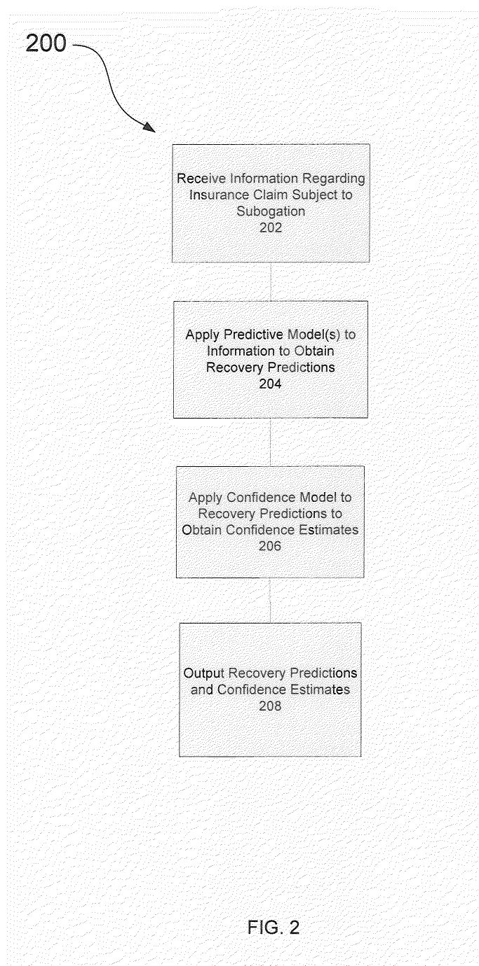

FIG. 2 is a flow chart that illustrates an example of a process 200 by which the subrogation of an insurance claim by a Demanding Carrier may be evaluated using the system 100 shown in FIG. 1. The process shown in FIG. 2 is not exhaustive of the actions the system may take. In a first stage, the inquiry portal 102 receives (202) information about an insurance liability dispute (e.g., a demand from a first insurance carrier for payment from a second insurance carrier of an insurance claim) from an insurance carrier, such as a user operating a client device 110 on behalf of the insurance carrier. For example, the information may include details about the insured party, the loss event, the type of insurance policy, among other things, that are entered into one or more fields on a web page hosted by the system 100. Once received, the information is transferred to the settlement evaluation module 104. The settlement evaluation module 104 may store the claim information in the database 108.

The settlement evaluation tool applies (204) one or more statistical models 106 to the information to obtain one or more outcome probabilities associated with strategies for resolving the dispute. As explained above, depending on the models applied, the output may include the likelihood of recovery for the claim under different recovery approaches, the projected recovery value under the different recovery approaches, the anticipated time until recovery for the different recovery approaches, and/or a historical analysis of the different recovery approaches sought for similar claims in the past. The output of the models can be stored in the database 108.

The settlement evaluation tool 104 then optionally may apply (206) the confidence model to the output of the statistical models. The confidence model determines the accuracy of the predictions obtained using the statistical models by, e.g., comparing actual outcomes for closed and settled claims for similar insurance claims. The confidence model may discard results from the statistical models that are outside a certain range of confidence. For example, statistical model results that are greater than 3 standard deviations apart from actual values may be discarded.

Once the statistical model assessments and, optionally, the confidence levels in the assessments are obtained, the settlement evaluation module 104 passes (208) the assessments and confidence estimates to the inquiry portal 102. The inquiry portal 102 then provides the assessments and confidence estimates to the client device 110. For example, a client device communicating with the inquiry portal 102 may load a webpage hosted by the inquiry portal 102 to display the assessment of the insurance claim with respect to recovery from the adverse carrier. The settlement evaluation module 104 also may store the assessments in the claim database 108. The newly stored assessments then may be considered part of the claim history and can be relied on by the settlement evaluation module 104 when determining adverse carrier negotiating behavior and applying the statistical models for future claims subject to subrogation.

The system 100 is configured to provide a data presentation format that includes the statistical model assessments, the confidence estimates, as well as additional information pertinent to the insurance claim to be subrogated. Such additional information includes, for example, the current state of the insurance claim (i.e., an indication of where the claim is in in the recovery process), an historical overview of events and/or milestones in the recovery process (e.g., date the claim was received, when review of the demand for subrogation began, when liability has been determined and by who, when a recovery approach has been selected), information about the claimant (e.g., name, contact information), information about the loss event (e.g., type of loss, where it occurred), information about the adverse carrier, and/or documents related to the insurance claim (e.g., receipts, estimates, police reports, witness statements, medical information, fire reports, IA reports, and communications sent as part of the subrogation activity). The data presentation format can present the foregoing information on an interactive webpage.

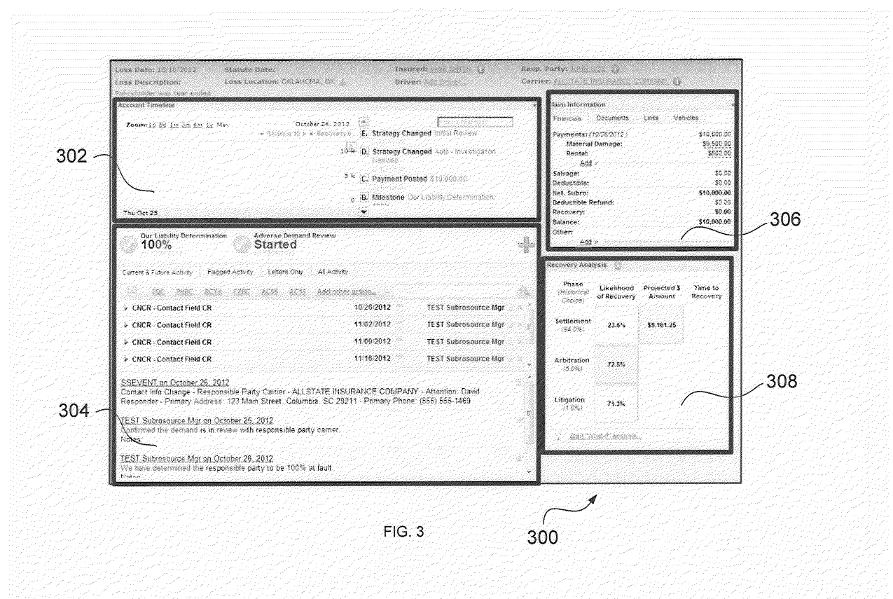

FIG. 3 is a screenshot of an example settlement evaluation page 300 viewable with a web browser and hosted by the inquiry portal 102. As shown in the example screenshot, the settlement evaluation page organizes information about the claim into multiple different relevant areas. The page 300 provides a clear framework or central location for a user to understand the current state of the subrogation opportunity, including a history of the recovery process, and allows the user to benchmark the current state of the claim against other claims having similar characteristics (e.g., similar type of loss event, similar costs to claimant, similar adverse carrier, among other factors).

For example, the page 300 includes a first section 302 that provides a historical overview of the progress of recovery for the selected claim. The historical overview may include the balance remaining for the selected subrogation opportunity and a timeline for significant events in the recovery process.

The page 300 also may include a second section 304 that sets forth an interactive list of actions, interactions, and events related to the subrogation opportunity. The section 304 may allow the user to enter additional notes, information or mark the occurrence of events in the subrogation process. The actions, interactions, and events may be added manually by the user or may occur automatically. That is, the system 100 may automatically update the list as the system 100 obtains new information through extracting information from documents uploaded to the system 100. In addition, or alternatively, the system 100 may automatically update the list when the system 100 is integrated with carrier specific claim systems that contain the relevant data. In such cases, the system 100 may automatically access the relevant carrier databases to access and obtain data regarding events relevant to the recovery process for the insurance claim.

The page 300 also may include a third section 306 that provides the user with detailed information about the subrogation opportunity. The detailed information may include, for example, a financial breakdown of costs and recovered amounts to date, a listing of documentation relevant to the claim and the subrogation opportunity (accessible, e.g., by hyper-links), a description of the insured property that was damaged, and/or a listing of the hyper-links to third party information that may be useful to the user (e.g., third party estimates for salvage and repair costs). The detailed information may be subdivided and accessed using different tabs.

The page 300 also may include a fourth section 308 that details the recovery analysis as obtained from the settlement evaluation module. The recovery analysis provides the user with information about where in the recovery cycle (e.g., settlement, arbitration, or litigation) the optimal outcome may be achieved, what is the likelihood of recovery, what is the projected amount of recovery, and/or what is the anticipated time until recovery. The recovery analysis may also indicate to the user the confidence estimates of the predicted values.

The page 300 also may include additional features that allow the user to ascertain the optimal recovery outcome. For example, the page 300 may include an interactive feature (e.g., link, button) that, once activated, provides the user with an interactive map at the location where the loss occurred. The map may include satellite and street views to allow the user to better assess the environment in which the loss occurred.

In another example, the page 300 may include an interactive tool/feature that allows the user to modify the claim features the statistical models rely on when providing the recovery assessment and confidence estimates. The interactive tool thus allows a user to obtain revised recovery assessment and confidence estimates based on a modification of the data. For instance, in some cases, a claim is entered into the system 100 but does not yet include all of the relevant information relating to the loss event. For example, information relating to who the adverse carrier is, estimates for salvage or repair costs, and/or total payments incurred by the carrier for the event may not be known at the time the claim is entered. The system 100 may include a tool that allows the user to enter guesses or assumptions for those missing factors in order to obtain the optimal recovery assessment under different scenarios. This “what-if” analysis allows the user to anticipate what is likely to be the optimal recovery strategy and make an informed decision on the best path forward to take.

In certain implementations, some or all of the foregoing information may help the user make rapid, accurate and more confident decisions as to how to proceed with respect to resolving a claim. In addition, because the user is provided the optimal strategy for recovery for each claim, the carrier may achieve the benefit of increased revenues from improved efficiency and greater recovery amounts. Furthermore, the assessments provided by the models may allow greater automation of the recovery process. For example, in circumstances where the likelihood of recovery is very high (e.g., greater than 80%, greater than 85%, greater than 90%, or greater than 95%) for a particular recovery approach (settlement, arbitration or litigation), the system 100 may automatically select the optimal approach without input from a user. Automatic selection may entail, for example, automatically sending a notification (e.g., e-mail message) to the adverse carrier of the particular recovery approach the Demanding Carrier will pursue for the claim. This may include setting forth a recovery value the Demanding Carrier will accept for settlement of the claim. Alternatively, or in addition, the automatic selection may entail automatically accepting an offer of payment from the adverse carrier. In any of the foregoing examples, such automatic selection may be implemented through exchange of electronic messages between the system 100 and one or more client devices operated by an adverse carrier.

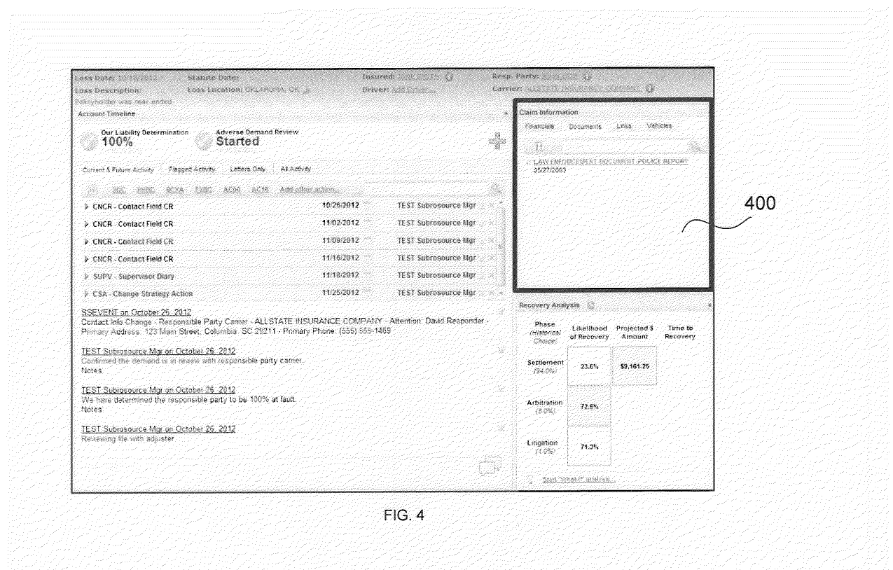

FIG. 4 is a screenshot of an example settlement evaluation page that includes a section 400 for presenting the user with hyper-links to documents relevant to the selected claim subject to subrogation. Various documents may be included in this section such as, for example, cost estimates for parts, labor, and salvage, receipts for costs already incurred, among others. As shown in the example of FIG. 4, a police report describing a loss event is posted in the section 400.

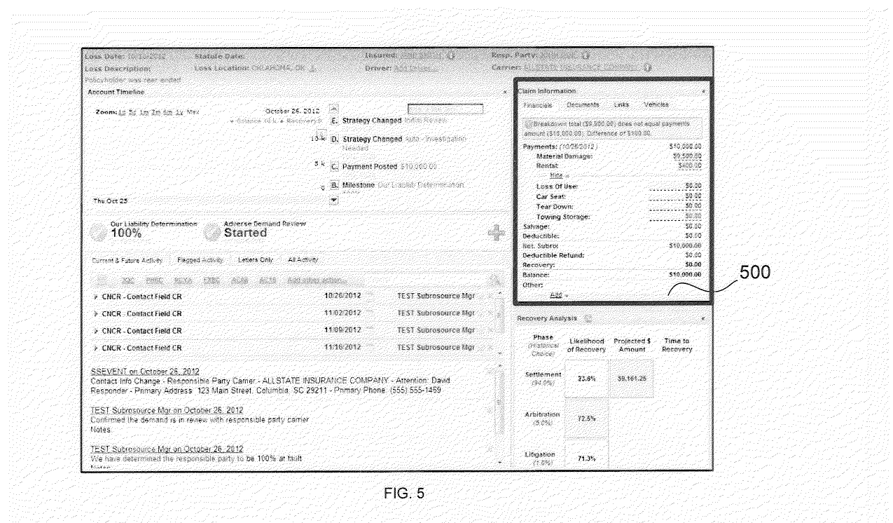

FIG. 5 is a screenshot of an example settlement evaluation page that includes a section 500 for presenting the user with a financial breakdown of costs and recovered amounts to date for the claim subject to subrogation. The financial breakdown includes, for example, the material damages to the property covered by an insurance policy, costs due to the loss event (e.g., rental costs, loss of use costs, towing costs, cost of replacing child car seat), payment received for salvage and deductibles. The financial breakdown may also include the amount recovered so far from the adverse carrier and the balanced owed to the Demanding Carrier in the recovery process.

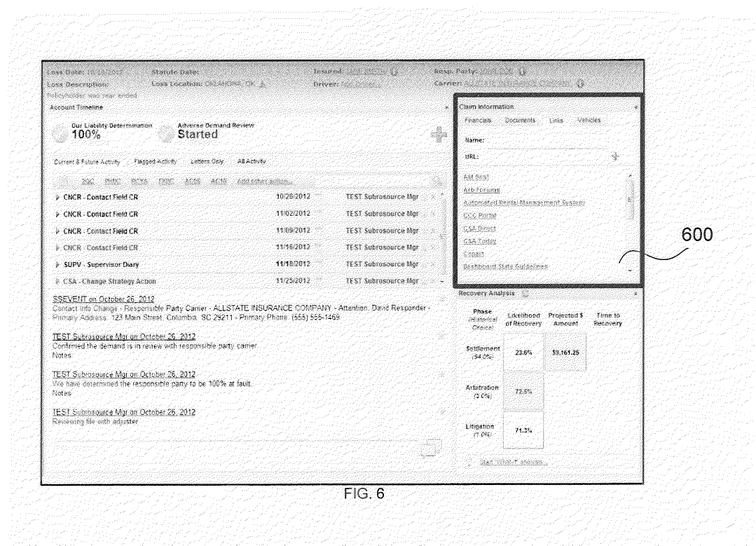

FIG. 6 is a screenshot of an example settlement evaluation page that includes a section 600 for presenting the user with links to websites that may be relevant to the selected claim subject to subrogation. For example, the section 600 may include links to third party sites that provide the user with cost estimates for replacement parts and salvage value.

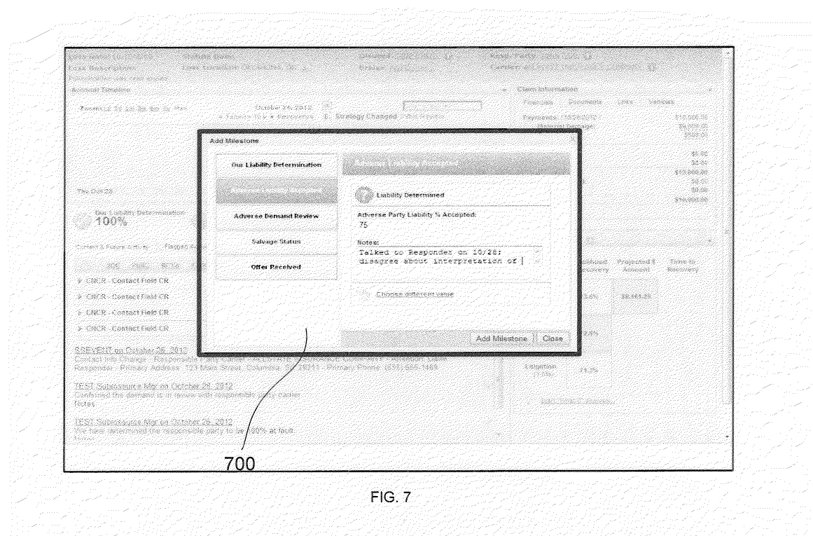

In some implementations, the settlement evaluation page enables the user to manually update the claim to include relevant events or “milestones” in the recovery process. FIG. 7 is a screenshot of an example settlement evaluation page that includes an interactive pop-up window 700 in which a user can enter milestone information. The pop-up window 700 may be activated be selecting an interactive icon on the settlement evaluation page. Various different milestones may be recorded by the system 100 for a particular claim subject to subrogation.

For example, a first type of milestone is a Demanding Carrier's rating of the adverse carrier percentage of liability. This milestone gives the percentage of liability attributed to the adverse carrier by the Demanding Carrier. This milestone may be entered manually by a user or specialist working the account. Alternatively, the system 100 may identify the milestones automatically by evaluating the strategy actions that have been previously entered into the system 100. In addition, the system 100 may automatically update the milestones if the system 100 is integrated with carrier specific claim systems that contain the relevant data, as explained above. The Demanding Carrier rating of the adverse carrier liability milestone is used to determine whether there is subrogation potential and, depending on the degree of liability (e.g., if partial liability), in which states (under various negligence laws), a subrogation claim can be filed.

A second type of milestone is an adverse carrier's rating of adverse liability percentage. This milestone gives the percentage of liability attributed to the Responding Carrier by the Responding Carrier (i.e., the Demanding Carrier's rating of its own liability). When considered against the Demanding Carrier rating of the adverse carrier liability, this milestone indicates whether there is a liability dispute between the two carriers and to what degree there is a difference between the carrier's identification of liability. This milestone may be entered manually by a user or obtained automatically by the system 100 though the uploading of negotiating documents from the Responding Carrier or by direct integration with the Responding Carrier claim systems.

A third type of milestone is the Demand Review Started milestone. This milestone indicates the date and time when a third party review of the demand was started. Knowing when important pieces of the subrogation process occur may, in certain implementations, aid the models in more accurately predicting the expected time till recovery is obtained, and may also provide the user with an ability to understand the time required to complete a demand review. This milestone may be entered manually by a user or obtained automatically by the system 100. For example, the system 100 may interrogate actions previously entered in the system to determine whether a milestone occurred (e.g., if attorney referral action is in the system, the legal milestone can be identified by the system 100). In another example, the system 100 can capture the Responding Carrier's confirmation of a demand review started automatically.

A fourth type of milestone is the Demand Review Completed milestone. This milestone indicates the date and time when a demand review was completed. In combination with the Demand Review Started milestone, it may be possible for a user to assess the time required to complete a demand review. The timing data may also be stored as historical data on which the statistical models may rely when evaluating future claims.

A fifth type of milestone is the Salvage Status Outstanding milestone. This milestone indicates whether a claim involves the processing of salvage materials. The process of selling salvage items adds time to the subrogation process, but also reduces the total claim dollars to be recovered. As such, this milestone may be used by the statistical models to predict the time course of recovery, but also changes the dynamics of the negotiation process by reducing the amount of claim dollars to be negotiated.

A sixth type of milestone is the Salvage Status Retained milestone. This milestone indicates that the insured party has kept their vehicle/other property despite its damaged status, and indicates that the amount of the claim should be reduced by the amount of the property value retained by the insured party. This milestone may also be used by the statistical models to predict the overall time to recovery of the remaining claim dollars by identifying the date and time at which this part of the process was completed.

A seventh type of milestone is the Salvage Status Received milestone. This milestone indicates that the dollars recovered from the sale of the salvage have been received. This milestone indicates the completion of this phase of the subrogation process, and not only ensures that representatives will no longer have to monitor the salvage process, but also aids the models in predicting the overall time to recovery.

An eighth type of milestone is the Settlement Offer Accepted milestone. This milestone indicates the dollar amount which was offered by the adverse carrier and accepted by the Demanding Carrier settlement representative. This milestone serves several purposes including, for example, to indicate the amount that was recovered through the settlement process (as opposed to an escalation process such as arbitration or litigation), and to demarcate the cycle time from demand to offer. The statistical models may use this information for assessing how the adverse carrier will resolve a future similar claim and the length of time associated with the recovery process.

A ninth type of milestone is the Settlement Offer Not Accepted milestone. This milestone indicates the dollar amount which was offered by the adverse carrier, but not accepted by the Demanding Carrier's settlement representative. This milestone not only serves to demarcate the time spent from demand to offer by settlement representatives (even when an offer is not accepted), but also may be used by the statistical models to evaluate the net costs of escalating a claim to determine the optimal recovery approach (i.e., settlement versus arbitration or litigation).

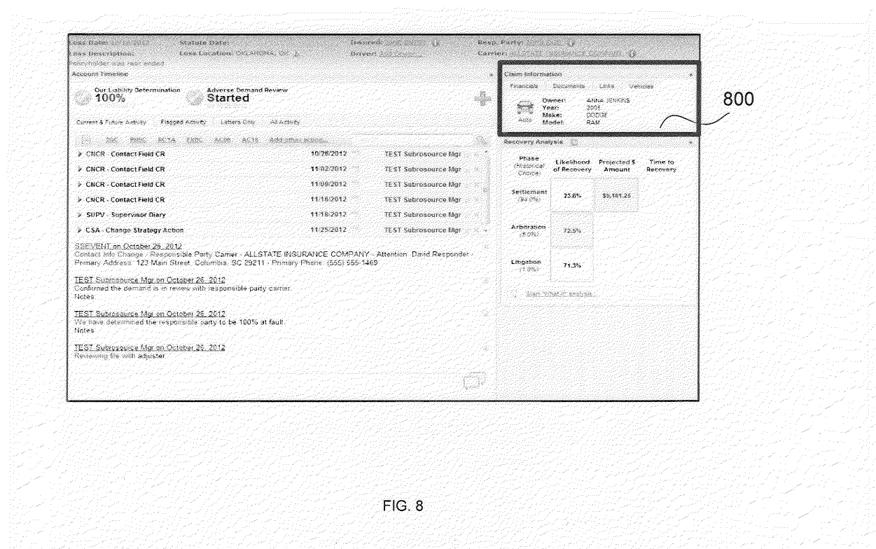

FIG. 8 is a screenshot of an example settlement evaluation page that includes a section 800 for presenting the user with details on the property that was damaged in the loss event. In the example shown in FIG. 8, the section 800 displays information relating to the year, make and model of a car damaged in a loss event as well as the owner of the damaged property.

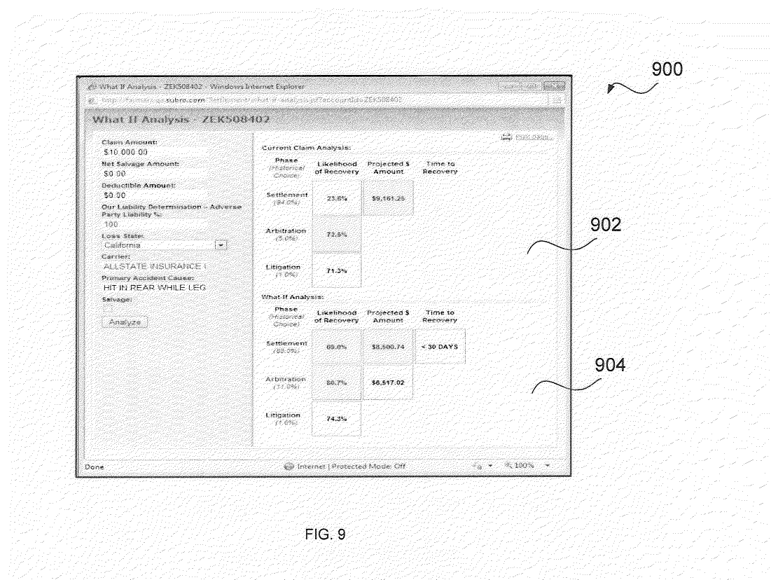

FIG. 9 is a screenshot of a section 900 that provides the user with information about the recovery analysis. The section 900 may be part of the settlement evaluation page or may be expanded as a stand-alone page viewable by the user. The recovery analysis provides the user with information about where in the recovery cycle (e.g., settlement, arbitration, or litigation) the optimal outcome may be achieved, what is the likelihood of recovery, what is the projected amount of recovery, and/or what is the anticipated time until recovery. The recovery analysis may also indicate to the user the confidence estimates of the predicted values.

As shown in the example of FIG. 9, the recovery analysis is presented in a table format. Of course, the information also may be presented in other ways, such as using a chart or in text alone. The section 900 contains two separate sub-parts: a current claim analysis section 902 and a “what-if” analysis section/tool 904. As explained above, the “what-if” analysis allows a user to modify the values relating to the claim that are input into the statistical models so as to evaluate the optimal recovery strategy under different scenarios. The current claim analysis section provides the recovery analysis as determined by the statistical models for the information currently associated with the selected insurance claim.

The tables in each of the current claim analysis and what-if analysis sections are arranged as a 4 by 3 grid. The first column in each table represents the percentage of similar claims that have been settled in the different recovery phases (i.e., settlement, arbitration or litigation). A similar claim is determined based on a particular set of characteristics associated with the currently selected claim. The user may select which characteristics of the current claim are relevant for the comparison (e.g., the user may select the type of event loss, the location, the adverse carrier, etc.). The settlement evaluation module 104 will then only incorporate claims having those same or similar characteristics when performing the assessment. The second column in each table represents the likelihood of recovery for the different recovery phases. The third column in each table represents the projected recovery amount (e.g., in a dollar amount) in each of the different recovery phases. The fourth column in each table represents the projected time until recovery is obtained (e.g., time until the maximum possible payment is received from the adverse carrier). As can be seen in the example shown in FIG. 9, the statistical models may not be able to provide projections for each of the different scenarios. In such cases, there may not be enough historical data from which the statistical models can perform the assessment.

The tables presented in section 900 also may indicate the confidence estimate for each of the predictions. The confidence estimate may be presented as a separate table or as text. Alternatively, the confidence estimate may be presented using a visual indicator. For example, in some implementations, the confidence estimate may be shown by shading the different cells of each table a different color based on the level of confidence of the projection contained in that cell. For instance, a high confidence in the projected value (e.g., greater than 90% confidence) may be displayed by shading the cell green. A medium level of confidence in the projected value (e.g., between 60% and 90%) may be displayed by shading the cell yellow. A low level of confidence in the projected value (e.g., less than 60%) may be displayed by shading the cell red. Alternatively, if a projection is not accurate enough, the cell may just be left empty.

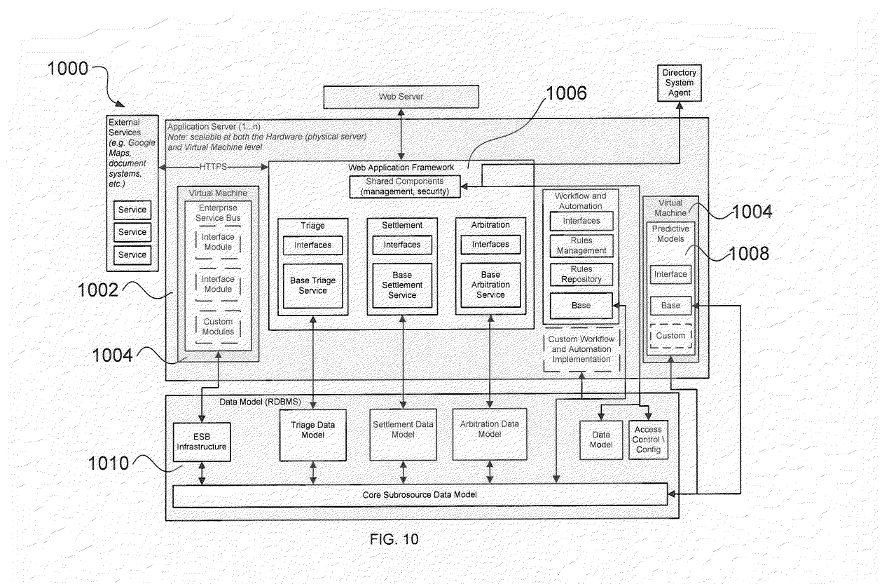

FIG. 10 is a schematic that illustrates an example of an application framework 1000 on which the configuration of system 100 may be based. Other frameworks also may be used that provide the operations and services of the subrogation and settlement system described herein. As shown in FIG. 10, the application framework 1000 may include one or more application servers 1002. Several virtual machines 1004 may be configured to operate across the one or more servers 1002. The virtual machines 1004, in turn, may be configured to implement various different aspects of the inquiry portal and the settlement evaluation module of the system. As shown in FIG. 10, the different aspects of the system are presented in a modular arrangement. For example, the servers 1002 may be configured to implement a web application framework 1006 for establishing the inquiry portal through which carriers may check on the status of claims and the recovery process, and provide information to the system. The virtual machines 1004 may be configured to execute the statistical models 1008. Both the web application framework and the virtual models may communicate and transfer information with the data model 1010. The data model 1010 is configured to store, in one or more models and/or databases, historical information relating to previous claims. In some implementations, the output of the statistical models for a current claim is transferred to the data model 1010 to be used as part of a historical analysis for future recovery assessments.

### Additional Implementation Details

Various aspects of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The terms “data processing apparatus” and “computer” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks.

However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the invention. Accordingly, other implementations are within the scope of the following claims.

What is claimed is:

1. A system comprising:
a settlement evaluation module comprising a statistical model; and
an inquiry portal module, wherein the inquiry portal module is configured to perform operations comprising:
providing an interactive user interface for display on a display device,
electronically receiving, from the interactive user interface, data related to a subrogation demand from a first insurance carrier against a second insurance carrier for an insurance claim covering a loss event,
transferring the data to the settlement evaluation module, and
wherein the settlement evaluation module is configured to perform operations comprising:
applying the statistical model to the data to obtain an outcome probability associated with a strategy for resolving the subrogation demand, and
outputting the outcome probability to the inquiry portal module for display within the interactive user interface, wherein the interactive user interface includes the outcome probability associated with the strategy, an historical overview of events related to the subrogation demand, information about the loss event, a status of the subrogation demand, or combinations thereof.

2. The system of claim 1, wherein the interactive user interface is configured to include an interactive tool that allows a user to obtain a revised outcome probability based on a modification of the data.

3. The system of claim 1, wherein the strategy for resolving the subrogation demand comprises seeking settlement of the dispute, seeking arbitration of the dispute, litigating the dispute, or combinations thereof, and wherein the outcome probability comprises a probability that the second insurance carrier submits a payment to the first insurance carrier, a projected payment amount to the first insurance carrier from the second insurance carrier upon resolution of the dispute, a projected time until the first insurance carrier will recover a payment from the second insurance carrier, or combinations thereof.

4. A computer-implemented method comprising:
electronically providing, from a first data processing apparatus to a second data processing apparatus, data related to a subrogation demand from a first insurance carrier against a second insurance carrier for an insurance claim covering a loss event;
electronically receiving from the second data processing apparatus an outcome probability associated with a strategy for resolving the subrogation demand, wherein the outcome probability is obtained by applying a statistical model to the data related to the subrogation demand; and
presenting the outcome probability within an interactive user interface on a display device.

5. The computer-implemented method of claim 4, wherein the interactive user interface comprises information comprising an historical overview of events related to the subrogation demand, information about the loss event, a status of the subrogation demand, or combinations thereof.

6. The computer-implemented method of claim 4, wherein the strategy for resolving the subrogation demand comprises seeking settlement of the dispute, seeking arbitration of the dispute, litigating the dispute, or combinations thereof, and wherein the outcome probability comprises a probability that the second insurance carrier submits a payment to the first insurance carrier, a projected payment amount to the first insurance carrier from the second insurance carrier upon resolution of the dispute, a projected time until the first insurance carrier will recover a payment from the second insurance carrier, or combinations thereof.

7. A system comprising:
a settlement evaluation module comprising a statistical model; and
an inquiry portal module, wherein the inquiry portal module is configured to perform operations comprising:
electronically receiving data related to an insurance liability dispute between a first insurance carrier and a second insurance carrier, and
transferring the data to the settlement evaluation module, and
wherein the settlement evaluation module is configured to perform operations comprising:
applying the statistical model to the data to obtain an outcome probability associated with a strategy for resolving the dispute, and
outputting the outcome probability.

8. The system of claim 7, wherein the settlement evaluation module comprises a database configured to store actual outcomes of prior disputes between insurance carriers, outcome probabilities associated with prior disputes between insurance carriers, or combinations thereof, and wherein the statistical model is constructed based on the actual outcomes of the prior disputes, the outcome probabilities associated with the prior disputes, or the combinations thereof.

9. The system of claim 7, wherein the dispute comprises a demand from the first insurance carrier for payment from the second insurance carrier for an insurance claim submitted by a party insured by the first insurance carrier.

10. The system of claim 9, wherein the insurance claim covers a loss event and wherein the data related to the dispute comprises information about a type of loss that occurred in the loss event, a description of the loss event, a location where the loss event occurred, environmental conditions associated with the loss event, information about the second insurance carrier, information about costs associated with the loss event, or combinations thereof.

11. The system of claim 7, wherein the settlement evaluation module is configured to perform operations further comprising applying a plurality of statistical models to the data to obtain a plurality of outcome probabilities, each outcome probability being associated with a different strategy for resolving the dispute.

12. The system of claim 11, wherein the plurality of outcome probabilities comprise a probability that a resolution to the dispute includes payment from the second insurance carrier to the first insurance carrier, a projected payment amount to the first insurance carrier from the second insurance carrier upon resolution of the dispute, a projected time until the first insurance carrier will recover a payment from the second insurance carrier, or combinations thereof.

13. The system of claim 11, wherein the different strategies for resolving the dispute comprise seeking settlement of the dispute, seeking arbitration of the dispute, litigating the dispute, or combinations thereof.

14. The system of claim 7, wherein the settlement evaluation module is configured to perform operations further comprising:
applying an additional statistical model to the outcome probability to obtain a confidence estimate in the outcome probability; and
outputting the confidence estimate to the inquiry portal module.

15. The system of claim 14, wherein the inquiry portal module is configured to perform operations further comprising displaying a visual indicator to indicate the confidence estimate, wherein the visual indicator includes a color-coded indicator of the confidence estimate.

16. The system of claim 7, wherein the settlement evaluation module is configured to perform operations further comprising identifying a probability that the strategy for resolving the dispute will be used.

17. A computer-implemented method comprising:
electronically receiving, at one or more data processing apparatuses, data related to an insurance liability dispute between a first insurance carrier and a second insurance carrier;
using the one or more data processing apparatuses to apply a statistical model to the data to obtain an outcome probability associated with a strategy for resolving the dispute; and
outputting the outcome probability.

18. The computer-implemented method of claim 17, wherein the statistical model is constructed based on the actual outcomes of the prior disputes, the outcome probabilities associated with the prior disputes, or the combinations thereof.

19. The computer-implemented method of claim 17, wherein the dispute comprises a demand from the first insurance carrier for payment from the second insurance carrier for an insurance claim submitted by a party insured by the first insurance carrier.

20. The computer-implemented method of claim 19, wherein the insurance claim covers a loss event and wherein the data related to the dispute comprises information about a type of loss that occurred in the loss event, a description of the loss event, a location where the loss event occurred, environmental conditions associated with the loss event, information about the second insurance carrier, information about costs associated with the loss event, or combinations thereof.

21. The computer-implemented method of claim 17, further comprising using the one or more data processing apparatuses to apply a plurality of statistical models to the data to obtain a plurality of outcome probabilities, each outcome probability being associated with a different strategy for resolving the dispute.

22. The computer-implemented method of claim 21, wherein the plurality of outcome probabilities comprise a probability that a resolution to the dispute includes payment from the second insurance carrier to the first insurance carrier, a projected payment amount to the first insurance carrier from the second insurance carrier upon resolution of the dispute, a projected time until the first insurance carrier will recover a payment from the second insurance carrier, or combinations thereof.

23. The computer-implemented method of claim 21, wherein the different strategies for resolving the dispute comprise seeking settlement of the dispute, seeking arbitration of the dispute, litigating the dispute, or combinations thereof.

24. The computer-implemented method of claim 17, further comprising:
using the one or more data processing apparatuses to apply an additional statistical model to the outcome probability to obtain a confidence estimate in the outcome probability; and
outputting the confidence estimate to the inquiry portal module.

25. The computer-implemented method of claim 24, wherein the inquiry portal module is configured to perform operations further comprising displaying a visual indicator to indicate the confidence estimate, wherein the visual indicator includes a color-coded indicator of the confidence estimate.

26. The computer-implemented method of claim 17, further comprising identifying a probability that the strategy for resolving the dispute will be used.
